(19) United States
(12) Patent Application Publication
(10) Pub. No.: US 2009/0245870 A1
(43) Pub. Date: Oct. 1, 2009

(54) IMAGE FORMING APPARATUS

(75) Inventor: Daijirou Ueno, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/408,800

(22) Filed: Mar. 23, 2009

(30) Foreign Application Priority Data
Mar. 26, 2008 (JP) 2008-081860

(51) Int. Cl. G03G 15/00

(52) U.S. Cl. 399/167

(57) ABSTRACT

An image forming apparatus includes a drive transmission system for driving a rotatable image carrier, a rotating status detecting section for detecting data relating to a rotating status of the image carrier, a rotating speed controller for controlling a rotating speed of the image carrier, and a rotation precision analyzer for calculating rotation precision information, based on the rotating status data detected by the rotating status detecting section. The rotation precision analyzer is operable to cause the rotating speed controller to change the rotating speed of the image carrier in a predetermined range, cause the rotating status detecting section to detect rotating status data in the predetermined rotating speed range, and calculate rotation precision information, based on the rotating status data in the predetermined rotating speed range.

### BACKGROUND OF THE INVENTION

1. Field of the Invention

The present invention relates to an electrophotographic image forming apparatus, such as a copying machine, a printer, a facsimile machine, and a complex machine thereof.

2. Description of the Background Art

An image forming apparatus has a rotating member such as a photosensitive drum, and the rotating speed of the rotating member is ordinarily controlled. In the case where the rotating speed of a photosensitive drum is not uniform, in other words, in the case where a rotation variation or a like drawback has occurred, it is difficult to obtain a high-precision image.

A rotation variation may occur resulting from a vibration due to mesh of gears, cogging of a motor, eccentricity of a drive shaft, or a like condition. In the case where the vibration resonates with a natural frequency of a rotating member or a gear case, a larger vibration may be generated, which may cause a larger rotation variation or breakage of an image forming apparatus itself.

In view of the above, there are proposed various methods for suppressing the vibration. For instance, JP Hei 8-115041A (D1) recites an automatic inertia adjusting device for automatically adjusting the inertia of a drive transmission system. The device is operable to obtain a frequency response characteristic of a drive transmission system, and calculate a natural frequency of the drive transmission system based on the frequency response characteristic. Then, the device is operable to automatically adjust the inertia of the drive transmission system in such a manner that the calculated natural frequency does not coincide with a frequency of a vibrating source, such as the rotating number of a shaft and a gear constituting the drive transmission system, or a mesh frequency of gears.

JP2002-272156A (D2) recites a drive transmission device for absorbing a vibration by matching a natural frequency to be determined based on a rigidity of a drive system and a moment of inertia of a drive shaft, with a disturbance frequency depending on a rotating speed generated in a transmission mechanism unit.

Applying the arrangements recited in D1 and D2 enables to suppress generation of a vibration in an image forming apparatus, and suppress generation of a rotation variation, thereby enabling to obtain a high-precision image.

However, it is necessary to create a complex simulation model or mathematical formula in order to realize the arrangements recited in D1 and D2. Creating a complex simulation model or mathematical formula is cumbersome and difficult to practice. Also, it is indispensable to verify whether the simulation model or the mathematical formula is correct by way of an experiment in order to secure accuracy. This may require an additional operation.

### SUMMARY OF THE INVENTION

In view of the above, it is an object of the present invention to provide an image forming apparatus that enables to obtain a high-precision image, while preventing a rotation variation of a photosensitive drum with a simplified arrangement.

An image forming apparatus according to an aspect of the invention is operable to change the rotating speed of an image carrier in a predetermined range, and calculate rotation precision information, based on data relating to a rotating status of the image carrier in the predetermined rotating speed range.

These and other objects, features and advantages of the present invention will become more apparent upon reading the following detailed description along with the accompanying drawings.

### BRIEF DESCRIPTION OF THE DRAWINGS

FIG. 1 is a schematic sectional view showing an entire arrangement of a color printer embodying the invention.

FIG. 2 is a partially enlarged view showing essential parts of an image forming section and its vicinity in the color printer.

FIG. 3 is a perspective view for describing a drive transmission system of a photosensitive drum in the color printer.

FIG. 4 is a block diagram for describing how the rotating speed of a photosensitive drum is controlled in the color printer.

FIG. 5 is a graph showing a relation between a rotating speed of one photosensitive drum, and a rotation variation.

FIG. 6 is a first graph showing relations between the rotating speeds of four photosensitive drums, and rotation variations.

FIG. 7 is a second graph showing relations between the rotating speeds of four photosensitive drums, and rotation variations.

FIG. 8A is a diagram showing an indication of the color printer, specifically showing that the rotating statuses of all the photosensitive drums are in a satisfactory state.

FIG. 8B is a diagram showing an indication of the color printer, specifically showing that the rotating statuses of some of the photosensitive drums are in an unsatisfactory state.

FIG. 9 is a flowchart for describing an operation to be performed by the color printer.

### DETAILED DESCRIPTION OF THE PREFERRED EMBODIMENTS

In the following, an embodiment of the invention is described referring to the drawings. Elements having like reference numerals throughout the drawings have like arrangements, and description thereof is omitted herein.

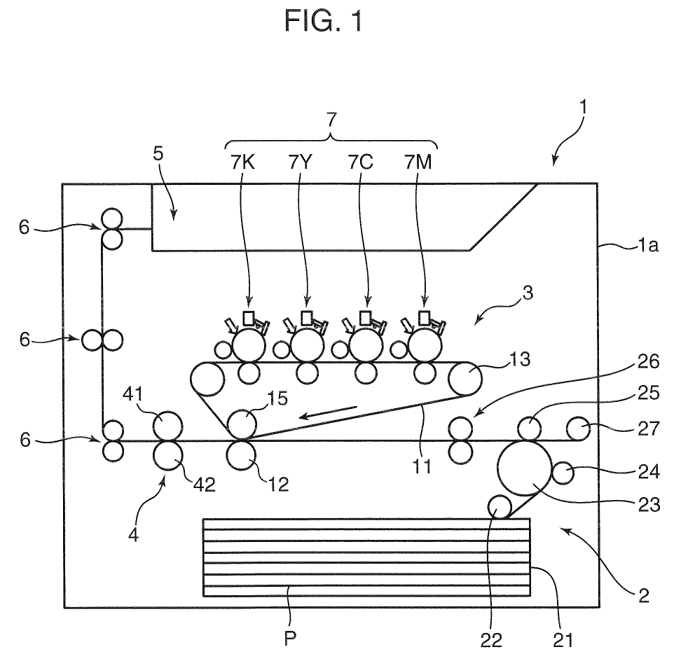

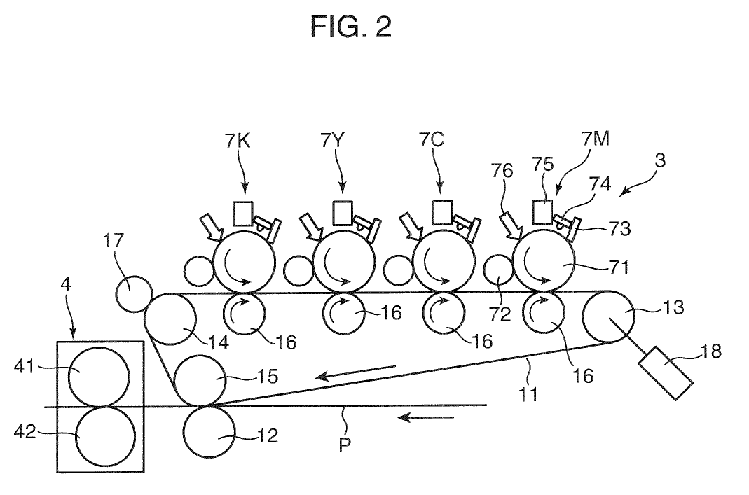

An entire arrangement of a tandem color printer, as an example of an image forming apparatus embodying the invention, is described referring to FIGS. 1 and 2. FIG. 1 is a schematic sectional view showing the entire arrangement of the color printer embodying the invention. FIG. 2 is a partially enlarged view showing essential parts of an image forming section and its vicinity in the color printer.

As shown in FIG. 1, the color printer 1 has a box-shaped apparatus body 1a. The apparatus body 1a is internally provided with a sheet feeding section 2 for feeding sheets P one by one, an image forming section 3 for transferring an image on a sheet P while transporting the sheet P fed from the sheet feeding section 2, and a fixing section 4 for fixing the image transferred to the sheet P in the image forming section 3. A sheet discharging section 5 for discharging the sheet P subjected to a fixing operation in the fixing section 4 is provided on a top part of the apparatus body la.

The sheet feeding section 2 includes: a sheet cassette 21 for storing sheets P of different sizes; a pickup roller 22 for feeding the sheets P stored in the sheet cassette 21 one by one; feed rollers 23, 24, and 25 for feeding the sheet P dispensed by the pickup roller 22 to a sheet transport path; a registration roller pair 26 for transporting the sheet P to the image forming section 3 at a predetermined timing, after temporarily holding the sheet P transported to the sheet transport path by the feed rollers 23, 24, and 25; and a pickup roller 27 for feeding a sheet P placed on a manual tray (not shown) mounted on a right wall of the apparatus body la in FIG. 1.

The sheet cassette 21 is detachably mounted to the apparatus body la. The pickup roller 22 is provided at an upper right position of the sheet cassette 21 in FIG. 1. A sheet P fed from the manual tray by the pickup roller 27 is transported to the sheet transport path by the feed rollers 23 and 25, and then transported to the image forming section 3 at a predetermined timing by the registration roller pair 26.

The image forming section 3 includes an image forming assembly 7, an intermediate transfer belt 11 having an outer surface (a contact surface) thereof on which a toner image is primarily transferred, and a secondary transfer roller 12 for secondarily transferring the toner image on the intermediate transfer belt 11 to a sheet P fed from the sheet feeding section 2.

The image forming assembly 7 has, from upstream side (left side in FIG. 1) toward downstream side in this order, a black imaging unit 7K, a yellow imaging unit 7Y, a cyan imaging unit 7C, and a magenta imaging unit 7M. Photosensitive drums 71, as an image carrier, are rotatably mounted at respective middle positions of the black imaging unit 7K, the yellow imaging unit 7Y, the cyan imaging unit 7C, and the magenta imaging unit 7M in the arrow directions (counterclockwise) in FIG. 2. A charger 75, an exposure device 76, a developer 72, a cleaner 73, and a charge remover 74 are arranged around each of the photosensitive drums 71 in this order from upstream side in the rotating direction of the photosensitive drum 71. Since the constructions of the photosensitive drums 71 are identical to each other, hereinafter, one of the photosensitive drums 71 is described as a representative, unless otherwise necessary.

The charger 75 is operable to uniformly charge a surface of the photosensitive drum 71, and is constituted of e.g. a scorotron charger. The exposure device 76 is a so-called laser scan unit. The exposure device 76 is operable to emit laser light based on image data inputted from an image reader or a like device, onto the surface of the photosensitive drum 71 uniformly charged by the charger 75, and form an electrostatic latent image on the surface of the photosensitive drum 71, based on the image data. The developer 72 is operable to form a toner image based on the image data by supplying a toner to the surface of the photosensitive drum 71 where the electrostatic latent image is formed. The toner image is primarily transferred to the intermediate transfer belt 11. The cleaner 73 is operable to remove toner residues from the surface of the photosensitive drum 71, after the primary transfer operation of transferring a toner image to the intermediate transfer belt 11 is completed. The charge remover 74 is operable to remove charge residues from the surface of the photosensitive drum 71, after the primary transfer operation is completed. After the surface of the photosensitive drum 71 is subjected to a cleaning operation by the cleaner 73 and the charge remover 74, the photosensitive drum 71 is rotated to face the charger 75 for a succeeding charging operation. Then, a succeeding primary transfer operation is performed.

The intermediate transfer belt 11 is an endless belt-like rotating member, and is wound around multiple rollers such as a drive roller 13, a belt support roller 14, a backup roller 15, and primary transfer rollers 16 in such a manner that the outer surface (contact surface) of the intermediate transfer belt 11 is contacted with the surfaces of the photosensitive drums 71. The intermediate transfer belt 11 is endlessly rotated by the multiple rollers in a state that the intermediate transfer belt 11 is pressed against the photosensitive drums 71 by the primary transfer rollers 16 disposed opposite to the counterpart photosensitive drums 71.

The drive roller 13 is operable to rotate by a driving source 18 such as a stepping motor, and apply a driving force to the intermediate transfer belt 11 to endlessly rotate the intermediate transfer belt 11. Preferably, the drive roller 13 may have an elastic layer made of urethane rubber or a like material on an outer surface thereof. Forming the elastic layer on the surface of the drive roller 13 is advantageous in suppressing a slip between the intermediate transfer belt 11 and the drive roller 13, and enhancing transmittance of driving force, thereby facilitating rotation of the intermediate transfer belt 11.

The belt support roller 14, the backup roller 15, and the primary transfer rollers 16 are rotatably supported. The belt support roller 14, the backup roller 15, and the primary transfer rollers 16 are driven rollers driven in response to an endless rotation of the intermediate transfer belt 11 by the drive roller 13. The belt support roller 14, the backup roller 15, and the primary transfer rollers 16 are driven by rotation of the drive roller 13 via the intermediate transfer belt 11, while supporting the intermediate transfer belt 11.

The primary transfer rollers 16 are each operable to apply a primary transfer bias voltage of a polarity opposite to the charging polarity of toner to the intermediate transfer belt 11. Thereby, toner images formed on the photosensitive drums 71 are successively and superimposedly transferred, by a primary transfer operation, between the respective corresponding photosensitive drums 71 and the respective corresponding primary transfer rollers 16, while the intermediate transfer belt 11 is circulated in the arrow direction (clockwise) by driving of the drive roller 13.

A cleaning brush 17 is mounted at an upper left position of the belt support roller 14 in FIG. 2. After toner images are transferred onto a sheet P, toner residues on the surface of the intermediate transfer belt 11 are removed by the cleaning brush 17. Thereby, the intermediate transfer belt 11 subjected to a cleaning operation is circulated to a predetermined position to face the photosensitive drums 71.

The secondary transfer roller 12 is operable to apply a secondary transfer bias voltage of a polarity opposite to the polarity of a toner image to a sheet P. Thereby, a primarily transferred toner image on the intermediate transfer belt 11 is transferred onto a sheet P between the secondary transfer roller 12 and the backup roller 15. Thus, a color transfer image is formed on the sheet P.

The fixing section 4 is operable to fix a toner image transferred to a sheet P in the image forming section 3, and includes the heater roller 41 which is heated by an energizing heating element, and the pressure roller 42 which is disposed opposite to the heater roller 41, and has an outer surface in pressing contact with an outer surface of the heater roller 41. A toner image transferred to a sheet P is thermally fixed, while the sheet P passes between the heater roller 41 and the pressure roller 42. After the fixing operation, the sheet P is discharged to the sheet discharging section 5. Transport roller pairs 6 are provided at appropriate positions between the fixing section 4 and the sheet discharging section 5.

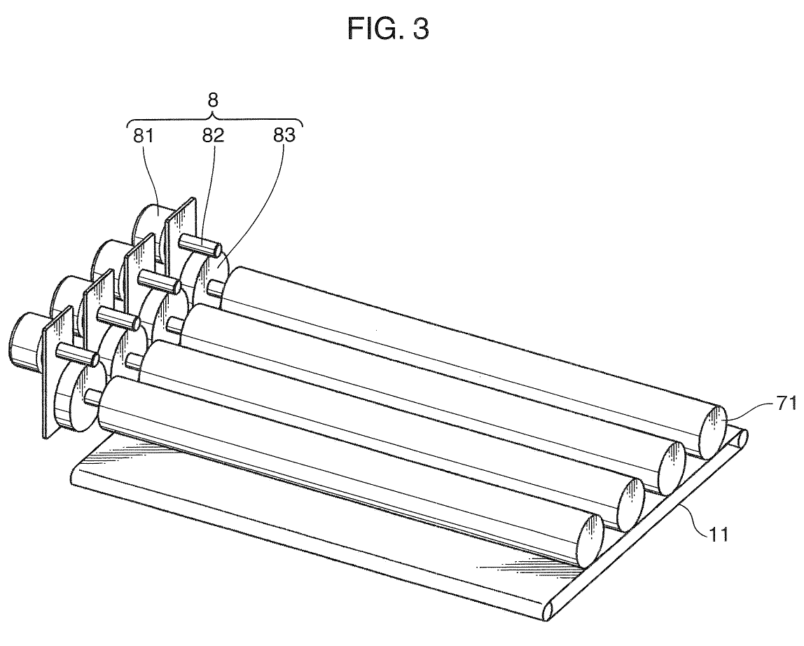

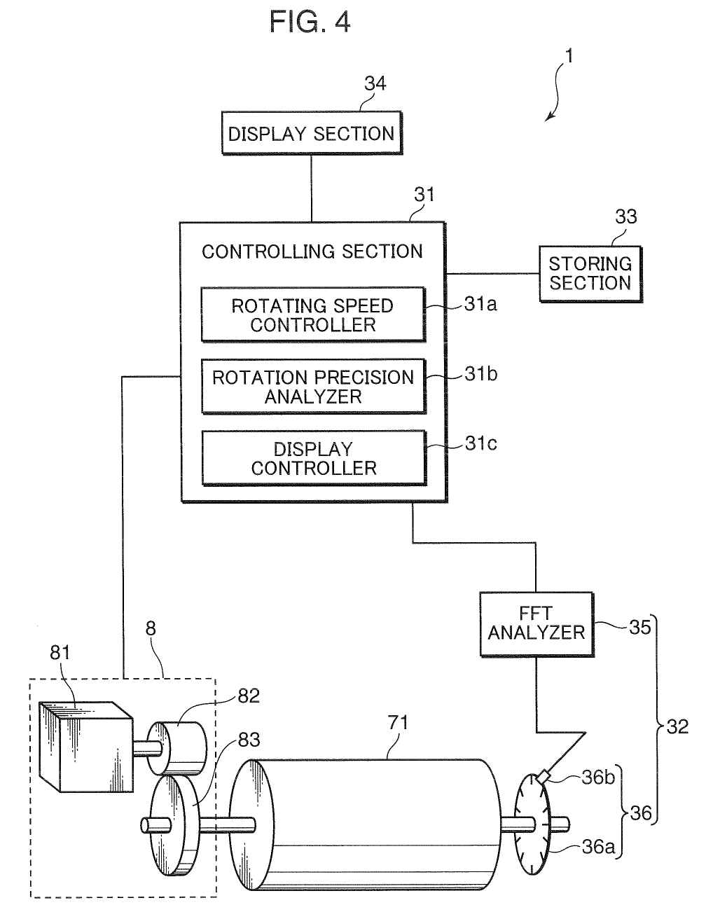

In the following, a rotation control mechanism of the photosensitive drums 71 (as an image carrier) in the color printer 1 is described referring to FIGS. 3 and 4. FIG. 3 is a perspective view for describing a drive transmission system of a photosensitive drum in the color printer of the embodiment. FIG. 4 is a block diagram for describing how the rotating speed of a photosensitive drum is controlled in the color printer of the embodiment.

First, an arrangement of the drive transmission system of a photosensitive drum is described. As shown in FIG. 3, a drive transmission system 8 includes a motor 81, a drive gear 82, and a driven gear 83. The motor 81, the drive gear 82, and the driven gear 83 are provided with respect to each of the photosensitive drums 71. In other words, four motors 81, four drive gears 82, and four driven gears 83 are provided in the color printer 1. The drive gear 82 coupled to a drive shaft of the motor 81 is rotated by driving the motor 81. The drive gear 82 is meshed with the driven gear 83 mounted at one end of the photosensitive drum 71. In this arrangement, the driven gear 83 is rotated in association with the rotation of the drive gear 82, thereby rotating the photosensitive drum 71.

In the following, an electrical configuration of the color printer 1, particularly, an arrangement of the rotation control mechanism of the photosensitive drums 71 is described. Referring to FIG. 4, the color printer 1 includes the photosensitive drums 71, the drive transmission systems 8, a controlling section 31, a rotating status detecting section 32, a storing section 33, and a display section 34. In the embodiment, four photosensitive drums 71, and four drive transmission systems 8 are provided for black image formation, yellow image formation, cyan image formation, and magenta image formation, respectively. However, for easy explanation, one of the photosensitive drums 71 and one of the drive transmission systems 8 are illustrated in FIG. 4.

The rotating status detecting section 32 is operable to detect data relating to a rotating status of the photosensitive drum 71. Rotating status data is data necessary for defining a rotating status of the photosensitive drum 71. In the embodiment, the rotating status indicates a rotation variation, a rotating speed, or a like parameter. The rotation variation indicates a speed fluctuation with respect to an average rotation speed. In the case where a rotation variation is obtained by an FFT (Fast Fourier Transform) analyzer, the rotation variation is calculated by summing up amplitudes at different frequencies. The rotating status detecting section 32 is constituted of a rotary encoder 36 for extracting a rotation signal indicating a rotating status of the photosensitive drum 71, as an electrical signal; and an FFT analyzer 35 for frequency-analyzing the signal from the rotary encoder 36. The rotary encoder 36 has a disc-shaped encoder disc 36a, and an encoder detecting section 36b provided with a light emitter mounted on one surface of the encoder disc 36a and a light receiver mounted on the other surface thereof. The encoder disc 36a has slits equidistantly formed around an outer perimeter thereof. Each of the slits extends radially inwardly toward the center of the encoder disc 36a from the outer perimeter thereof. The light emitter and the light receiver of the encoder detecting section 36b are arranged at such positions that light from the light emitter is received by the light receiver through one of the slits in the encoder disc 36a. The light receiver is operable to output light received from the light emitter, as an electrical signal. The electrical signal from the rotary encoder 36 is inputted to the FFT analyzer 35. The FFT analyzer 35 is operable to frequency-analyze the inputted signal.

Preferably, the FFT analyzer 35 is operable to receive a pulse signal, based on a drive signal for controlling the rotating speed of the motor 81, which is outputted from the controlling section 31. With use of the pulse signal, the FFT analyzer 35 is operable to accurately monitor the rotating speed of the motor 81. Thereby, the FFT analyzer 35 is allowed to perform high-precision frequency analysis. The rotating status detecting section 32 may exclude the FFT analyzer 35. In the case where the FFT analyzer 35 is not provided, frequency-analysis cannot be performed. However, the rotating speed of the photosensitive drum 71, or a rotation variation thereof can be sufficiently detected without the FFT analyzer 35. If complex and high-precision analysis such as analyzing a cause of rotation variation is necessary, the FFT analyzer 35 is necessary. For instance, a rotation variation may occur due to mesh of gears, cogging of a motor, eccentricity of a drive shaft, or a natural vibration. Frequency-analysis by the FFT analyzer 35 enables to specify a cause of rotation variation.

The storing section 33 includes a rewritable non-volatile EEPROM (Electrically Erasable Programmable Read Only Memory), and a volatile RAM (Random Access Memory). The controlling section 31 is operable to calculate rotation precision information including a relation between a rotating speed of each of the photosensitive drums 71, and a rotation variation, based on a frequency-analysis result relating to rotations of the photosensitive drums 71 by the FFT analyzer 35, and store the rotation precision information into the storing section 33. The storing section 33 is operable to store various data e.g. a rotation variation which is calculated by the controlling section 31, including an initial value of a rotation variation, each time computation is performed. Preferably, time information may be stored into the storing section 33 in association with the various data, when the controlling section 31 causes the storing section 33 to store the various data therein. The time information may include a current point of time when data is stored, or an integrated time from the point of time when an operation of the color printer 1 is started. Preferably, a rotating status of the photosensitive drum 71 may be stored in association with the various data. Thereby, current rotation precision information indicating a current rotating status of the photosensitive drum 71 can be calculated, considering previous rotation precision information indicating a previous rotating status of the photosensitive drum 71. This is advantageous in precisely calculating rotation precision information.

The display section 34 is operable to display a rotating status e.g. a value of a rotation variation, or an error message indicating that repair is necessary. The display section 34 may be e.g. a liquid crystal display or an organic EL display.

The controlling section 31 is operable to control a rotating speed of the photosensitive drum 71, analyze data relating to a rotating status of the photosensitive drum 71, control the photosensitive drum 71 to rotate at an appropriate rotating speed depending on the rotating status thereof, and control the individual parts of the color printer 1 to perform their functions thereof. The controlling section 31 is e.g. a microcomputer including a storing element for storing a control program, a microprocessor operable in accordance with a control program, and peripheral circuits thereof. The storing element is e.g. a non-volatile ROM (Read Only Memory), a rewritable non-volatile EEPROM (Electrically Erasable Programmable Read Only Memory), and a volatile RAM (Random Access Memory). The controlling section 31 functionally includes a rotating speed controller 31a, a rotation precision analyzer 31b, and a display controller 31c.

The rotating speed controller 31a is operable to control the rotating speed of the motor 81. Specifically, the rotating speed controller 31a has a motor driver for controlling the motor 81. Preferably, the rotating speed controller 31a further includes a pulse oscillator to transmit, to the FFT analyzer 35, a pulse signal based on a control signal to be outputted from the rotating speed controller 31a to the motor 81. Thereby, as described above, the FFT analyzer 35 is operable to accurately monitor the rotating speed of the photosensitive drum 71. If an appropriate rotating speed of the photosensitive drum 71 is calculated, based on an analysis result to be outputted from the rotation precision analyzer 31b, the rotating speed controller 31a is operable to control the motor 81 so that the rotating speed of the photosensitive drum 71 coincides with the appropriate rotating speed.

The rotation precision analyzer 31b is operable to calculate rotation precision information, based on rotating status data to be outputted from the rotating status detecting section 32. The rotation precision information indicates various parameters for use in determining a rotating status of the photosensitive drum 71, such as a rotation variation, or a relation between a rotating speed of the photosensitive drum 71 and a rotation variation. Alternatively, the rotation precision analyzer 31b may calculate rotation precision information, using previous rotation precision information stored in the storing section 33. For instance, it is possible to calculate a value of a rotation variation at a current time, referring to an initial value of a rotation variation. Defining the initial value of a rotation variation as a reference value is advantageous in easily recognizing a degree of deterioration of the rotating status of the photosensitive drum 71, and evaluating a rotation variation. A rotation variation or a like parameter calculated by the rotation precision analyzer 31b is stored in the storing section 33 in association with a rotating speed, time information, and the like.

The rotation precision analyzer 31b is operable to control the rotating speed controller 31a and the rotating status detecting section 32 to acquire rotating status data. The rotation precision analyzer 31b is operable to judge whether the rotating speed of the photosensitive drum 71 is proper, and define an appropriate rotating speed of the photosensitive drum 71, based on the calculated rotation precision information.

The display controller 31c is operable to display an image on the display section 34. For instance, in the case where the rotation precision analyzer 31b judges that the rotating speed of the photosensitive drum 71 is improper, the display controller 31c causes the display section 34 to display an indication to recognize an operator of the judgment result. The display controller 31c causes the display section 34 to discriminatively display a rotating speed zone where the rotating status of the photosensitive drum 71 is satisfactory, and a rotating speed zone where the rotating status of the photosensitive drum 71 is unsatisfactory. The display controller 31c may also cause the display section 34 to display a current rotating speed of the photosensitive drum 71, a rotation variation of the photosensitive drum 71, a frequency analysis result, an error message indicating that repair is necessary, and the like.

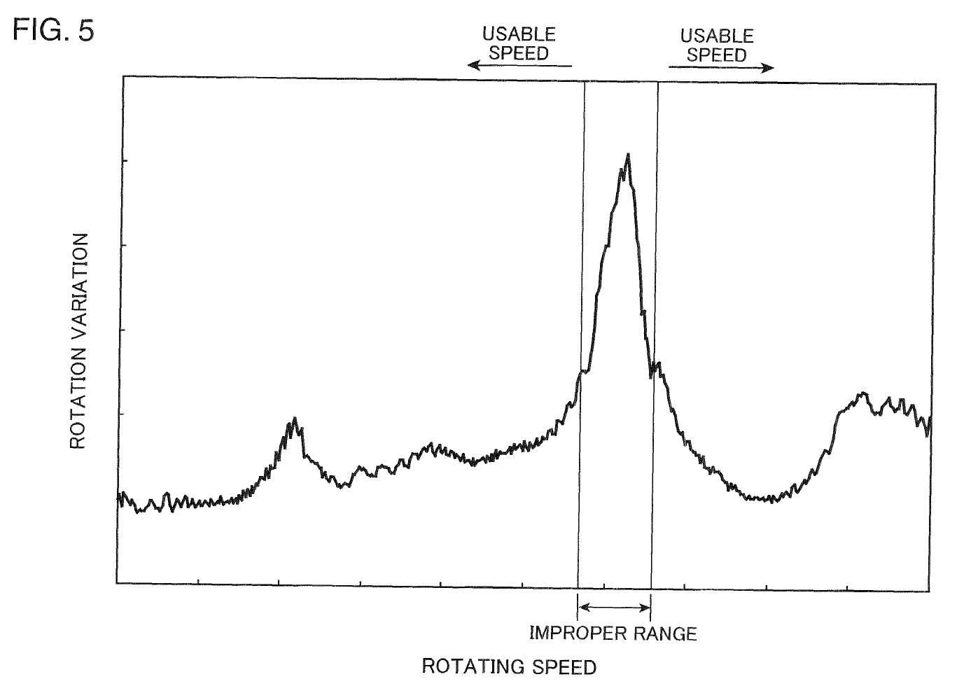

Next, there is described a method for judging whether the rotating speed of the photosensitive drums 71 is proper, and defining an appropriate rotating speed, which is to be performed by the rotation precision analyzer 31b. FIG. 5 is a graph showing a relation between a rotating speed of one photosensitive drum 71, and a rotation variation. First, in response to a request from the rotation precision analyzer 31b, the rotating speed controller 31a changes the rotating speed of the motor 81 in a predetermined range, and the FFT analyzer 35 frequency-analyzes a rotation signal to be outputted from the rotary encoder 36 while the motor 81 is rotated in the predetermined rotating speed range. Then, the rotation precision analyzer 31b calculates a relation between a rotating speed of the photosensitive drum 71 and a rotation variation, as shown in FIG. 5, based on rotating status data i.e. frequency analysis data to be outputted from the FFT analyzer 35. If a rotation variation of the photosensitive drum 71 is unduly large, it is impossible to obtain a high-precision image. In view of this, as shown in FIG. 5, the rotation precision analyzer 31b is operable to define a rotating speed range corresponding to an unduly large rotation variation, as an improper range (i.e. a second rotating speed zone) where the rotating status of the photosensitive drum 71 is unsatisfactory. As shown in FIG. 5, the rotation precision analyzer 31b is also operable to define a rotating speed range (i.e. a first rotating speed zone) other than the improper range, as a range where the rotating status of the photosensitive drum 71 is satisfactory i.e. a usable rotating speed range. Thus, the rotation precision analyzer 31b is operable to discriminate the first rotating speed zone where the rotating status of the photosensitive drum 71 is satisfactory, and the second rotating speed zone where the rotating status of the photosensitive drum 71 is unsatisfactory from each other.

Then, the rotation precision analyzer 31b is operable to define a rotating speed in the rotating speed range (i.e. the range other than the improper range) where the rotating status of the photosensitive drum 71 is satisfactory, as an appropriate rotating speed. Then, the rotation precision analyzer 31b is operable to request the rotating speed controller 31a to control the motor 81 so that the rotating speed of the photosensitive drum 71 coincides with the appropriate rotating speed. In defining the improper range, for instance, a rotating speed range where a rotation variation is over a predetermined threshold value may be defined as the improper range. Further alternatively, a range including a peak value of a rotation variation may be defined as the improper range.

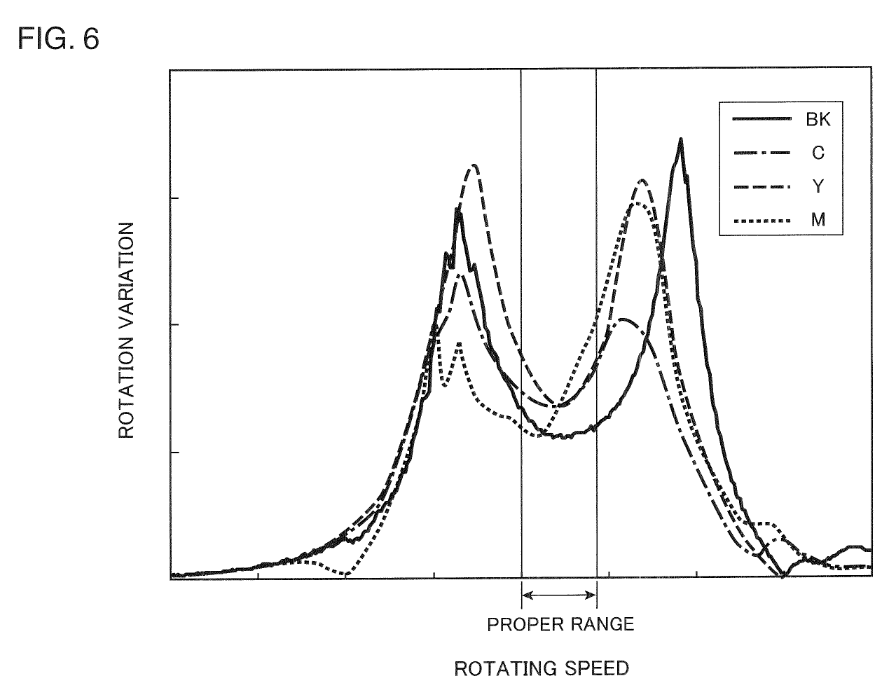

As described above, the color printer 1 has the four photosensitive drums 71 corresponding to black (BK), yellow (Y), cyan (C), and magenta (M), respectively. Relations between rotating speeds of the photosensitive drums 71, and rotation variations differ one from another. In other words, even if rotating speeds of the photosensitive drums 71 are identical to each other, it is highly likely that different rotating characteristics may appear depending on the photosensitive drums 71. Accordingly, it is desirable to integrally determine the rotating statuses of the four photosensitive drums 71 in defining an appropriate rotating speed. FIG. 6 is a first graph showing relations between rotating speeds of four photosensitive drums, and rotation variations. As shown in FIG. 6, even if rotating speeds of the photosensitive drums 71 are identical to each other, rotation variations are different among the photosensitive drums 71. The relations between rotating speeds and rotation variations as shown in FIG. 6 can be calculated in the similar manner as the case where the relation between a rotating speed and a rotation variation as shown in FIG. 5 is calculated.

Referring to FIG. 6, a rotating speed range where a rotation variation of each of the photosensitive drums 71 is relatively small corresponds to a rotating speed range where the rotating status of the photosensitive drums 71 as a whole is satisfactory. In this case, the rotation precision analyzer 31b is operable to define the rotating speed range where the rotating status of the photosensitive drums 71 as a whole is satisfactory, as a proper range (i.e. the first rotating speed zone). The rotation precision analyzer 31b is also operable to define a range other than the proper range, as a rotating speed range where the rotating status of the photosensitive drums 71 as a whole is unsatisfactory. The rotation precision analyzer 31b may discriminate the rotating speed range where the rotating statuses of all the photosensitive drums 71 are satisfactory from the rotating speed range where the rotating status of the photosensitive drums 71 as a whole is unsatisfactory, by judging whether a rotation variation of each of the photosensitive drums 71 is equal to or smaller than a predetermined threshold value. Further alternatively, the rotation precision analyzer 31b may discriminate the rotating speed range where the rotating statuses of all the photosensitive drums 71 are satisfactory from the rotating speed range where the rotating status of the photosensitive drums 71 as a whole is unsatisfactory, based on rotation precision information of a photosensitive drum 71 whose rotating status is most unsatisfactory, out of the four photosensitive drums 71. In other words, it is preferable to control the rotating speed of a photosensitive drum 71 having a largest rotation variation to such a value capable of reducing the rotation variation, out of the four photosensitive drums 71, in view of the overall rotating condition of the four photosensitive drums 71. For instance, referring to FIG. 6, a rotation variation of the photosensitive drum 71 corresponding to yellow (Y) or magenta (M) is relatively large. In this case, a rotating speed range where the rotation variation of the photosensitive drum 71 corresponding to yellow (Y) or magenta (M) is small is defined as a proper range i.e. a rotating speed range where the rotating status of the photosensitive drums 71 as a whole is satisfactory. In this way, an influence of rotation variation by the four photosensitive drums 71 as a whole can be minimized by defining a proper range, based on a photosensitive drum 71 whose rotating status is most unsatisfactory, out of the four photosensitive drums 71.

The rotation precision analyzer 31b is operable to define a rotating speed of the photosensitive drums 71 in a proper range i.e. a rotating speed range where the rotating status of the photosensitive drums 71 as a whole is satisfactory, as an appropriate rotating speed of the photosensitive drums 71. Then, the rotation precision analyzer 31b is operable to request the rotating speed controller 31b to control the motor 81 so that the rotating speed of each of the photosensitive drums 71 coincides with the appropriate rotating speed. FIG. 6 shows a measurement result that the photosensitive drums 71 are rotated beyond a rotating speed required for functioning the photosensitive drums 71 in a normal state. Accordingly, a left end region and a right end region in FIG. 6 correspond to non-standard rotating speeds of the photosensitive drums 71. The rotating speeds corresponding to the left end region and the right end region are unusable. Therefore, in an actual practice, it is not necessary to detect the rotating speeds corresponding to the left end region and the right end region in FIG. 6.

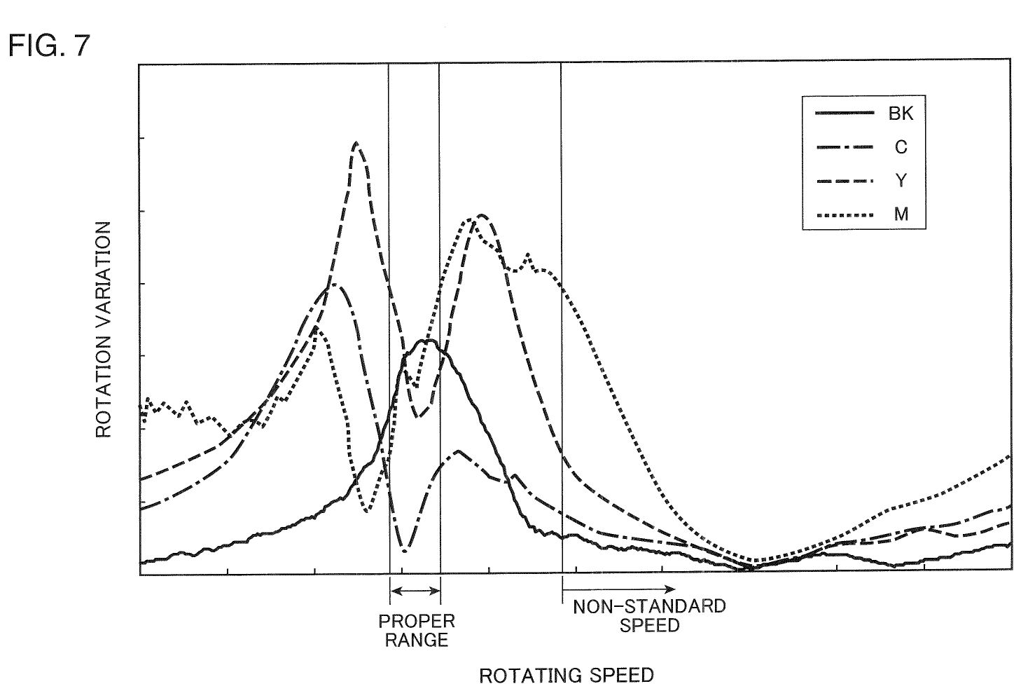

As described above, it is desirable to integrally define an appropriate rotating speed, considering rotation variations of all the photosensitive drums 71 with respect to the rotating speeds of all the photosensitive drums 71. FIG. 7 is a second graph showing relations between rotating speeds of four photosensitive drums, and rotation variations. For instance, referring to FIG. 7, rotating speed ranges of the three photosensitive drums 71 corresponding to yellow (Y), cyan (C), and magenta (M) having a relatively small rotation variation lie in a substantially identical region. The rotation variation of the photosensitive drum 71 corresponding to black (BK) has a peak value in the region. In this case, although the rotating status of the photosensitive drum 71 corresponding to black (BK) is not satisfactory, the rotating status of the photosensitive drums 71 as a whole is satisfactory. In this case, as shown in FIG. 7, the rotation precision analyzer 31b is operable to define the above region i.e. a rotating speed range where the rotating status of the photosensitive drums 71 as a whole is satisfactory, as a proper range, and an appropriate rotating speed is defined from the proper range.

As described above, the rotation precision analyzer 31b is operable to define an appropriate rotating speed of the photosensitive drums 71. However, there is a case that the rotating status of the photosensitive drums 71 as a whole is not satisfactory, even if the rotating speeds of the photosensitive drums 71 are changed. In other words, there is a case that there is no rotating speed range where the rotating status of the photosensitive drums 71 as a whole is satisfactory. In view of this, the rotation precision analyzer 31b is operable to issue an error signal, if it is judged that there is no rotating speed range where the rotating status of the photosensitive drums 71 as a whole is satisfactory.

As described above, in determining an appropriate rotating speed of the photosensitive drums 71, the rotation precision analyzer 31b is operable to calculate relations between rotating speeds of the photosensitive drums 71 and rotation variations. Alternatively, for instance, relations between rotating speeds of the photosensitive drums 71, and rotation variations may be obtained by measurement, and the measurement data may be stored in the storing section 33 in advance at the time of shipment of the color printer 1. The modification enables to define an appropriate rotating speed of the photosensitive drums 71, using the data stored in the storing section 33, without the need of calculating relations between rotating speeds of the photosensitive drums 71 and rotation variations.

Next, an operation to be performed by the display section 34 is described. As described above, the rotation precision analyzer 31b is operable to discriminate the rotating speed range where the rotating statuses of the photosensitive drums 71 are satisfactory, and the rotating speed range where the rotating statuses of the photosensitive drums 71 are unsatisfactory from each other. The display controller 31c is operable to cause the display section 34 to individually display the rotating speed range where the rotating statuses of the photosensitive drums 71 are satisfactory, and the rotating speed range where the rotating statuses of the photosensitive drums 71 are unsatisfactory, in response to a request from the rotation precision analyzer 31b. Thereby, the operator is allowed to visually recognize the rotating statuses of the photosensitive drums 71. In the case where the operator finds that one of the photosensitive drums 71 is in an unsatisfactory rotating status, the operator is prompted to take a proper measure by e.g. calling a serviceman.

For instance, in the case where a rotation variation of one of the photosensitive drums 71 exceeds a predetermined threshold value, preferably, the display controller 31c may cause the display section 34 to display that a rotation variation of one of the photosensitive drums 71 exceeds a predetermined threshold value, upon receiving rotation precision information from the rotation precision analyzer 31b. The predetermined threshold value may be defined based on a judgment whether image formation is affected. If the rotation variation is under the threshold value, the rotating status of the corresponding photosensitive drum 71 is judged to be satisfactory. On the other hand, if the rotation variation is over the threshold value, the rotating status of the corresponding photosensitive drum 71 is judged to be unsatisfactory.

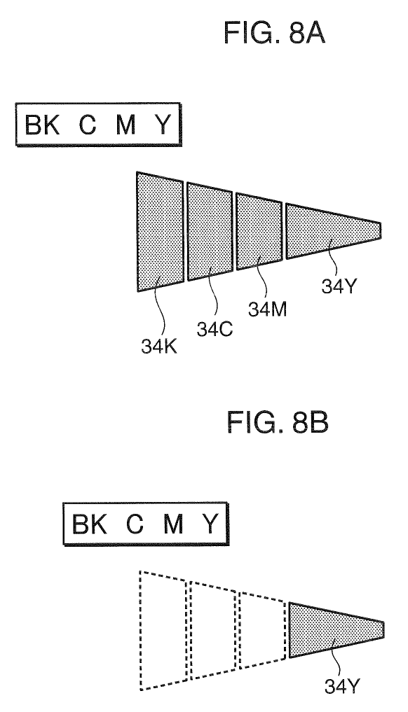

FIG. 8A is a diagram showing an indication of the color printer 1 in the embodiment, specifically, showing that the rotating statuses of all the photosensitive drums 71 are satisfactory. FIG. 8B is a diagram showing an indication of the color printer 1 in the embodiment, specifically, showing that the rotating statuses of some of the photosensitive drums 71 are unsatisfactory. Referring to FIGS. 8A and 8B, marks 34K, 34C, 34M, and 34Y are displayed in a row. The mark 34K indicates a rotating status of the photosensitive drum 71 corresponding to black (BK); the mark 34C indicates a rotating status of the photosensitive drum 71 corresponding to cyan (C); the mark 34M indicates a rotating status of the photosensitive drum 71 corresponding to magenta (M); and the mark 34Y indicates a rotating status of the photosensitive drum 71 corresponding to yellow (Y). If the rotating status of the photosensitive drums 71 as a whole is satisfactory, the display controller 31c is operable to cause the display section 34 to display all the marks 34K, 34C, 34M, and 34Y. However, if a rotating status of one of the photosensitive drums 71 is unsatisfactory, the display controller 31c is operable to cause the display section 34 not to display one of the marks 34K, 34C, 34M, and 34Y corresponding to the photosensitive drum 71 whose rotating status is unsatisfactory. For instance, in the case where the indication of the color printer 1 is as shown in FIG. 8A, the rotating statuses of all the photosensitive drums 71 are satisfactory, and rotation variations of all the photosensitive drums 71 are in an allowable range i.e. are smaller than a predetermined threshold value. In the case where the indication of the color printer 1 is as shown in FIG. 8B, rotation variations of the photosensitive drums 71 corresponding to black (BK), cyan (C), and magenta (M) are out of the allowable range i.e. are equal to or larger than the predetermined threshold value, and the rotating statuses of the photosensitive drums 71 corresponding to black (BK), cyan (C), and magenta (M) are unsatisfactory. Alternatively, the rotations variations may be displayed in terms of numerical values. For instance, the display controller 31c is operable to cause the display section 34 to display a value of a current rotation variation, referring to an initial value of a rotation variation which has been calculated by the rotation precision analyzer 31b and stored in the storing section 33.

Also, in the color printer 1, there is a case that a rotation variation cannot be reduced merely by adjusting the rotating speed of the corresponding photosensitive drum 71. In this case, the rotation variation may result from a natural vibration, or the photosensitive drum 71 may be out of order. In this case, maintenance service is required to eliminate the drawback. Specifically, as described above, the rotation precision analyzer 31b is operable to judge that there is no rotating speed range where the rotating status of the photosensitive drums 71 as a whole is satisfactory, and issue an error signal. In issuing an error signal, preferably, the display controller 31c is operable to cause the display section 34 to display an error message indicating that maintenance service is necessary. Thereby, the operator is accurately notified of a timing when maintenance service is necessary. Alternatively, the operator may be notified by way of a sound such as a buzzer, in place of or in combination with an error message.

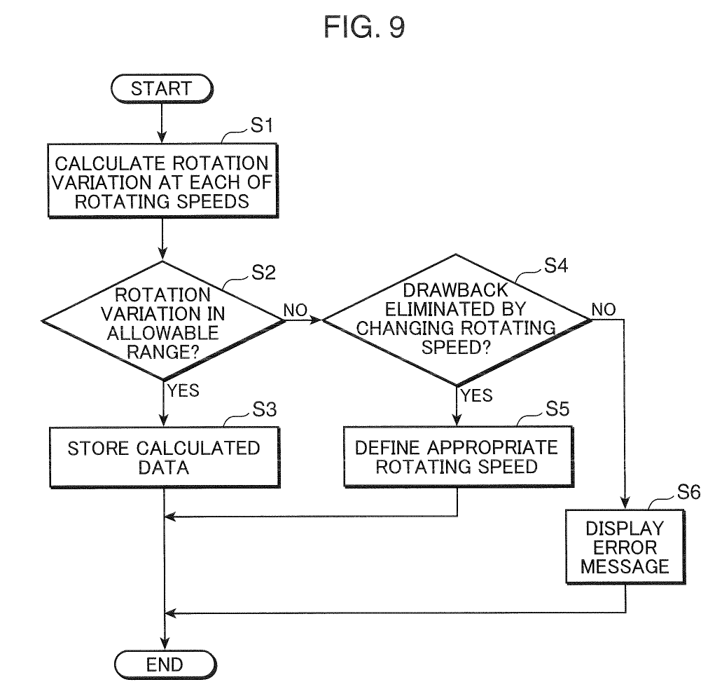

Next, an operation of the rotation control mechanism of the color printer 1 is described. FIG. 9 is a flowchart for describing an operation to be performed by the color printer 1. While the color printer 1 is operated, the rotating status detecting section 32 is operable to detect data relating to a rotating status of each of the photosensitive drums 71, and the controlling section 31 is operable to calculate a rotation variation of each of the photosensitive drums 71. In the case where the rotating speed of one of the photosensitive drums 71 is required to be changed e.g. in the case where the rotation variation of the corresponding photosensitive drum 71 is over an allowable range i.e. is equal to or larger than a predetermined threshold value, the controlling section 31 causes the display section 34 to display an indication indicating a request to change the rotating speed of the corresponding photosensitive drum 71. In the case where the rotation variation of the corresponding photosensitive drum 71 is over an allowable range, the controlling section 31 causes the display section 34 to display an indication that the rotation variation of the corresponding photosensitive drum 71 is over the allowable range. Thereby, the operator is allowed to designate the controlling section 31 to define an appropriate rotating speed through an operating section (not shown). Alternatively, the operator may designate the controlling section 31 to define an appropriate rotating speed through the operating section (not shown) at an appropriate timing, even if an indication indicating a request to change the rotating speed of the corresponding photosensitive drum 71 is not displayed on the display section 34. Further alternatively, in the case where a calculated rotation variation is over the allowable range, the controlling section 31 may automatically perform the following operation, assuming that the controlling section 31 is requested to define an appropriate rotating speed.

Specifically, upon receiving a designation to define an appropriate rotating speed, the controlling section 31 is operable to change the rotating speeds of the photosensitive drums 71 in a usable rotating speed range. More specifically, the controlling section 31 calculates a rotation variation at each of the rotating speeds of the photosensitive drums 71, based on rotating status data to be outputted from the rotating status detecting section 32 (Step S1). Then, the controlling section 31 judges whether a current rotation variation of a targeted photosensitive drum 71 lies in an allowable range (i.e. is smaller than a predetermined threshold value) (Step S2). Then, if the controlling section 31 judges that changing the rotating speed of the targeted photosensitive drum 71 is not necessary, because the current rotation variation lies in the allowable range (YES in Step S2), the controlling section 31 causes the storing section 33 to store data relating to the calculated rotation variation or a like parameter (Step S3). If the controlling section 31 judges that a current rotation variation of a targeted photosensitive drum 71 is over the allowable range (NO in Step S2), the controlling section 31 judges whether an unsatisfactory rotating state of the photosensitive drum 71 is eliminated by changing the rotating speed of the photosensitive drum 71 (Step S4). If the controlling section 31 judges that an unsatisfactory rotating state of the photosensitive drum 71 is eliminated by changing the rotating speed of the photosensitive drum 71 (YES in Step S4), the controlling section 31 controls the motor 81 to change the rotating speed of the photosensitive drum 71 so that the rotating speed of the photosensitive drum 71 coincides with an appropriate rotating speed (Step S5). If the controlling section 31 judges that an unsatisfactory rotating state of the photosensitive drum 71 is not eliminated by changing the rotating speed of the photosensitive drum 71 (NO in Step S4), the controlling section 31 causes the display section 34 to display an error message indicating that maintenance service is necessary (Step S6).

As described above, the color printer 1 of the embodiment is configured to calculate an optimum rotating speed free of a rotation variation, even if a rotation variation of one of the photosensitive drums 71 is detected; and eliminate the rotation variation by changing the rotating speed of the photosensitive drum 71. This is advantageous in securely obtaining a high-quality image.

In the foregoing, described is an arrangement that rotation variations of the photosensitive drums 71 are constantly monitored. Alternatively, rotation variations may be periodically detected, or detected at a predetermined time. For instance, rotation variations may be detected each time the number of image forming operations has reached a predetermined value, or at a timing when an electric power is supplied to an image forming apparatus.

The specification discloses the aforementioned various arrangements. The following is a summary of the embodiment.

An image forming apparatus according to an aspect of the invention includes: a drive transmission system for driving a rotatable image carrier; a rotating status detecting section for detecting data relating to a rotating status of the image carrier; a rotating speed controller for controlling a rotating speed of the image carrier; and a rotation precision analyzer for calculating rotation precision information, based on the rotating status data detected by the rotating status detecting section, wherein the rotation precision analyzer is operable to cause the rotating speed controller to change the rotating speed of the image carrier in a predetermined range, cause the rotating status detecting section to detect rotating status data in the predetermined rotating speed range, and calculate rotation precision information, based on the rotating status data in the predetermined rotating speed range.

The above arrangement enables to obtain a relation between a rotating speed of the image carrier, and a rotation variation. The above arrangement also enables to calculate a detailed parameter, or analyze a relation between the parameters, based on the detected rotating status data. This is advantageous in accurately analyzing the rotating status of the image carrier.

In the image forming apparatus, preferably, the rotation precision analyzer may be operable to discriminate a first rotating speed zone where the rotating status of the image carrier is satisfactory, and a second rotating speed zone where the rotating status of the image carrier is unsatisfactory from each other, based on the calculated rotation precision information, and the rotating speed controller may be operable to drive the image carrier at a rotating speed in the first rotating speed zone.

A satisfactory rotating status means a rotating status capable of forming a high-precision image, and an unsatisfactory rotating status means a rotating status incapable of forming a high-precision image. A judgment as to whether the rotating status is satisfactory can be made based on e.g. a value of a rotation variation.

In the above arrangement, since the rotating speed of the image carrier can be changed to obtain a satisfactory rotating status, this arrangement enables to eliminate an unsatisfactory rotating status. Thus, the above arrangement enables to avoid an unsatisfactory rotating status of the image carrier due to a rotation variation of the image carrier or a like drawback, and retain a satisfactory rotating status of the image carrier. This is advantageous in obtaining a high-precision image.

Preferably, the image forming apparatus may further include a storing section for storing previous rotation precision information calculated by the rotation precision analyzer, wherein the rotation precision analyzer is operable to use the previous rotation precision information stored in the storing section in calculating the rotation precision information.

The above arrangement enables to precisely calculate the rotation precision information. For instance, a value of a rotation variation or a like parameter at a current point of time can be calculated, referring to an initial value of a rotation variation. This is advantageous in evaluating a rotation variation.

In the image forming apparatus, preferably, the rotation precision analyzer may be operable to issue an error signal, if it is judged that there is no first rotating speed zone.

In the above arrangement, an operator can recognize a condition that the rotating status of the image carrier cannot be improved by changing the rotating speed of the image carrier. This enables the operator to accurately recognize a maintenance timing of the image forming apparatus.

An image forming apparatus according to another aspect of the invention includes: a drive transmission system for driving a rotatable image carrier; a rotating status detecting section for detecting data relating to a rotating status of the image carrier; a rotating speed controller for controlling a rotating speed of the image carrier; and a display section for displaying an indication relating to a judgment result as to whether the rotating status of the image carrier is satisfactory, wherein the display section is operable to discriminatively display at least a first rotating speed zone where the rotating status of the image carrier is satisfactory, and a second rotating speed zone where the rotating status of the image carrier is unsatisfactory, and the rotating speed controller is operable to change the rotating speed of the image carrier from the second rotating speed zone to the first rotating speed zone.

A satisfactory rotating status means a rotating status capable of forming a high-precision image, and an unsatisfactory rotating status means a rotating status incapable of forming a high-precision image. A judgment as to whether the rotating status is satisfactory can be made based on e.g. a value of a rotation variation.

In the above arrangement, in the case where the rotating status of the image carrier is unsatisfactory because of a rotation variation or a like drawback, the operator can visually recognize the unsatisfactory rotating status of the image carrier. Further, since the rotating speed of the image carrier can be changed, the unsatisfactory rotating status can be eliminated. Accordingly, the above arrangement enables to avoid an unsatisfactory rotating status of the image carrier due to a rotation variation or a like drawback, and retain a satisfactory rotating status of the image carrier. This is advantageous in obtaining a high-precision image.

Preferably, the image forming apparatus may further include a rotation precision analyzer for calculating rotation precision information, based on the rotating status data detected by the rotating status detecting section.

The rotation precision information includes various parameters for detecting a rotating status of the image carrier e.g. a rotation variation, or a relation between a rotating speed and a rotation variation.

The above arrangement enables to calculate a detailed parameter, or analyze a relation between the parameters, based on the detected rotating status data. This is advantageous in accurately analyzing the rotating status of the image carrier. Accordingly, the above arrangement enables to avoid an unsatisfactory rotating status of the image carrier due to a rotation variation or a like drawback, and retain a satisfactory rotating status of the image carrier. This is advantageous in obtaining a high-precision image.

Preferably, the image forming apparatus may further include a storing section for storing previous rotation precision information calculated by the rotation precision analyzer, wherein the rotation precision analyzer is operable to use the previous rotation precision information stored in the storing section in calculating the rotation precision information.

The above arrangement enables to precisely calculate the rotation precision information. For instance, a value of a rotation variation or a like parameter at a current point of time can be calculated, referring to an initial value of a rotation variation. This is advantageous in evaluating a rotation variation.

In the image forming apparatus, preferably, the rotation precision analyzer may be operable to cause the rotating speed controller to change the rotating speed of the image carrier in a predetermined range, cause the rotating status detecting section to detect rotating status data in the predetermined rotating speed range, calculate rotation precision information based on the rotating status data in the predetermined rotating speed range, and discriminate the first rotating speed zone and the second rotating speed zone from each other.

The above arrangement enables to obtain a relation between a rotating speed of the image carrier and a rotation variation. Further, the above arrangement enables to discriminate the first rotating speed zone and the second rotating speed zone from each other based on the relation. Thus, a rotating speed of the image carrier to obtain a satisfactory rotating status of the image carrier can be calculated. Accordingly, the above arrangement is advantageous in securely suppressing generation of a rotation variation, and securely obtaining a satisfactory rotating status of the image carrier.

In the image forming apparatus, preferably, the image carrier may be multiple photosensitive drums, and the rotation precision analyzer may be operable to discriminate the first rotating speed zone and the second rotating speed zone from each other, based on the rotation precision information of all the photosensitive drums.

In the above arrangement, an appropriate rotating speed of the image carrier can be defined, based on relations between the rotating speeds of all the photosensitive drums and rotation variations. This enables to securely suppress generation of a rotation variation.

In the image forming apparatus, preferably, the rotation precision analyzer may be operable to discriminate the first rotating speed zone and the second rotating speed zone from each other, based on the rotation precision information of a photosensitive drum in a most unsatisfactory rotating status, out of the multiple photosensitive drums.

The above arrangement is advantageous in securely suppressing a rotation variation of the photosensitive drums.

In the image forming apparatus, preferably, the rotation precision analyzer may be operable to issue an error signal, if it is judged that there is no first rotating speed zone.

In the above arrangement, an operator can recognize a condition that the rotating status of the image carrier cannot be improved by changing the rotating speed of the image carrier. This enables the operator to accurately recognize a maintenance timing of the image forming apparatus.

This application is based on Japanese Patent Application No. 2008-81860 filed on Mar. 26, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
a drive transmission system for driving a rotatable image carrier;
a rotating status detecting section for detecting data relating to a rotating status of the image carrier;
a rotating speed controller for controlling a rotating speed of the image carrier; and
a rotation precision analyzer for calculating rotation precision information, based on the rotating status data detected by the rotating status detecting section, wherein
the rotation precision analyzer is operable to cause the rotating speed controller to change the rotating speed of the image carrier in a predetermined range, cause the rotating status detecting section to detect rotating status data in the predetermined rotating speed range, and calculate rotation precision information, based on the rotating status data in the predetermined rotating speed range.

2. The image forming apparatus according to claim 1, wherein
the rotation precision analyzer is operable to discriminate a first rotating speed zone where the rotating status of the image carrier is satisfactory, and a second rotating speed zone where the rotating status of the image carrier is unsatisfactory from each other, based on the calculated rotation precision information, and
the rotating speed controller is operable to drive the image carrier at a rotating speed in the first rotating speed zone.

3. The image forming apparatus according to claim 1, further comprising:
a storing section for storing previous rotation precision information calculated by the rotation precision analyzer, wherein
the rotation precision analyzer is operable to use the previous rotation precision information stored in the storing section in calculating the rotation precision information.

4. The image forming apparatus according to claim 2, wherein
the rotation precision analyzer is operable to issue an error signal, if it is judged that there is no first rotating speed zone.

5. An image forming apparatus comprising:
a drive transmission system for driving a rotatable image carrier;
a rotating status detecting section for detecting data relating to a rotating status of the image carrier;
a rotating speed controller for controlling a rotating speed of the image carrier; and
a display section for displaying an indication relating to a judgment result as to whether the rotating status of the image carrier is satisfactory, wherein
the display section is operable to discriminatively display at least a first rotating speed zone where the rotating status of the image carrier is satisfactory, and a second rotating speed zone where the rotating status of the image carrier is unsatisfactory, and
the rotating speed controller is operable to change the rotating speed of the image carrier from the second rotating speed zone to the first rotating speed zone.

6. The image forming apparatus according to claim 5, further comprising:
a rotation precision analyzer for calculating rotation precision information, based on the rotating status data detected by the rotating status detecting section.

7. The image forming apparatus according to claim 6, further comprising:
a storing section for storing previous rotation precision information calculated by the rotation precision analyzer, wherein
the rotation precision analyzer is operable to use the previous rotation precision information stored in the storing section in calculating the rotation precision information.

8. The image forming apparatus according to claim 6, wherein
the rotation precision analyzer is operable to cause the rotating speed controller to change the rotating speed of the image carrier in a predetermined range, cause the rotating status detecting section to detect rotating status data during a period when the rotating speed of the image carrier is changed, calculate rotation precision information based on the rotating status data during the period when the rotating speed of the image carrier is changed, and discriminate the first rotating speed zone and the second rotating speed zone from each other.

9. The image forming apparatus according to claim 7, wherein
the rotation precision analyzer is operable to cause the rotating speed controller to change the rotating speed of the image carrier in a predetermined range, cause the rotating status detecting section to detect rotating status data in the predetermined rotating speed range, calculate rotation precision information, based on the rotating status data of the image carrier in the predetermined rotating speed range, and discriminate the first rotating speed zone and the second rotating speed zone from each other.

10. The image forming apparatus according to claim 2, wherein
the image carrier is multiple photosensitive drums, and
the rotation precision analyzer is operable to discriminate the first rotating speed zone and the second rotating speed zone from each other, based on the rotation precision information of all the photosensitive drums.

11. The image forming apparatus according to claim 6, wherein
the image carrier is multiple photosensitive drums, and
the rotation precision analyzer is operable to discriminate the first rotating speed zone and the second rotating speed zone from each other, based on the rotation precision information of all the photosensitive drums.

12. The image forming apparatus according to claim 10, wherein
the rotation precision analyzer is operable to discriminate the first rotating speed zone and the second rotating speed zone from each other, based on the rotation precision information of a photosensitive drum in a most unsatisfactory rotating status, out of the multiple photosensitive drums.

13. The image forming apparatus according to claim 11, wherein
the rotation precision analyzer is operable to discriminate the first rotating speed zone and the second rotating speed zone from each other, based on the rotation precision information of a photosensitive drum in a most unsatisfactory rotating status, out of the multiple photosensitive drums.

14. The image forming apparatus according to claim 6, wherein
the rotation precision analyzer is operable to issue an error signal, if it is judged that there is no first rotating speed zone.
